(19) United States
(12) Patent Application Publication
(10) Pub. No.: US 2026/0012214 A1
(43) Pub. Date: Jan. 8, 2026

(54) COMMUNICATION APPARATUS AND COMMUNICATION SYSTEM

(71) Applicant: KDDI CORPORATION, Tokyo (JP)

(72) Inventors: Taishi WATANABE, Fujimino-shi (JP); Takeo OHSEKI, Fujimino-shi (JP)

(21) Appl. No.: 19/329,727

(22) Filed: Sep. 16, 2025

Related U.S. Application Data
(63) Continuation of application No. PCT/JP2024/009928, filed on Mar. 14, 2024.

(30) Foreign Application Priority Data
Mar. 28, 2023 (JP) 2023-051452

(51) Int. Cl. H04B 1/10; H04B 1/18; H04B 7/005

(52) U.S. Cl. CPC H04B 1/10; H04B 1/18; H04B 7/005

(57) ABSTRACT

A communication apparatus performs to: receive, from a transmitter, a backoff change amount indicating an amount by which a backoff amount of the transmitter has changed from a reference value, and a transmission signal transmitted by the transmitter; and compensate for distortion of the transmission signal using a compensation model for use in processing to compensate for the distortion of the transmission signal transmitted from the transmitter, the compensation model being determined based on the backoff change amount.

### CROSS-REFERENCE TO RELATED APPLICATION(S)

This application is a continuation of International Patent Application No. PCT/JP2024/009928 filed on March 14, 2024, which claims priority to and the benefit of Japanese Patent Application No. 2023-051452 filed on March 28, 2023, the entire disclosures of which are incorporated herein by reference.

### BACKGROUND OF THE INVENTION

### Field of the Invention

The present invention relates to a communication apparatus and a communication system.

### Description of the Related Art

A technique called backoff is known, in which the maximum output power level of a communication apparatus is limited such that the signal output from a power amplifier remains within its linear region (e.g., see Japanese Patent Laid-Open No. 2019-510392).

### SUMMARY OF THE INVENTION

It is assumed that a transmitter reduces backoff to improve the efficiency of the power amplifier, and increase backoff to reduce interference with other nearby communication apparatuses. When the transmitter changes backoff, the state of nonlinear distortion of a signal that a receiver receives from the transmitter changes. A change in the state of nonlinear distortion of the received signal may make the receiver unable to properly compensate for the distortion of the received signal, resulting in degraded communication quality.

The present invention has been made in view of those points, and aims to suppress degradation of communication quality when the transmitter performs backoff.

A communication apparatus according to a first aspect of the present invention includes: a receiving unit configured to receive, from a transmitter, a backoff change amount indicating an amount by which a backoff amount of the transmitter has changed from a reference value, and a transmission signal transmitted by the transmitter; and a compensation unit configured to compensate for distortion of the transmission signal using a compensation model for use in processing to compensate for the distortion of the transmission signal transmitted from the transmitter, the compensation model being determined based on the backoff change amount.

The communication apparatus may further include a storage unit configured to store a plurality of compensation models in association with backoff change amounts, and the compensation unit may determine a compensation model stored in the storage unit in association with the backoff change amount received by the receiving unit as the compensation model for use in the processing to compensate for the distortion of the transmission signal. The communication apparatus may further include a model creation unit configured to, upon receiving input of the backoff change amount and a reference signal that is the transmission signal received by the receiving unit and having a known characteristic, create the compensation model corresponding to the backoff change amount, based on the reference signal.

The model creation unit may create the compensation model capable of reducing a difference between a undistorted base reference signal and the reference signal.

The model creation unit may create a plurality of compensation models, and determine, as the compensation model corresponding to the backoff change amount, one compensation model with which a signal obtained after the compensation unit compensates for the reference signal has relatively good quality, out of the plurality of created compensation models.

A communication apparatus according to a second aspect of the present invention includes: a receiving unit configured to receive backoff change information indicating that a backoff amount of a transmitter has changed, and a transmission signal transmitted by the transmitter; a model creation unit configured to, in response to the receiving unit receiving a reference signal that is the transmission signal having a known characteristic when receiving the backoff change information, create a compensation model for use in processing to compensate for distortion of the transmission signal transmitted from the transmitter, based on the received reference signal; and a compensation unit configured to compensate for the distortion of the transmission signal using the compensation model created by the model creation unit.

The compensation unit may cause the model creation unit to start an operation of creating the compensation model in response to the receiving unit receiving the backoff change information, and cause the model creation unit to stop the operation of creating the compensation model after the model creation unit has created the compensation model.

A communication system according to a third aspect of the present invention includes: a transmitter; and a receiver configured to receive a transmission signal transmitted by the transmitter, the transmitter including: a backoff control unit configured to change a backoff amount; and a transmission unit configured to transmit a backoff change amount that is an amount by which the backoff amount changes from a reference value, and the transmission signal, the receiver including: a receiving unit configured to receive the backoff change amount and the transmission signal; and a compensation unit configured to compensate for distortion of the transmission signal using a compensation model for use in processing to compensate for distortion of the transmission signal transmitted from the transmitter, the compensation model being determined based on the backoff change amount.

A communication system according to a fourth aspect of the present invention includes: a transmitter; and a receiver configured to receive a transmission signal transmitted by the transmitter, the transmitter including: a backoff control unit configured to change a backoff amount; and a transmission unit configured to transmit backoff change information indicating that the backoff amount has changed, and the transmission signal, the receiver including: a receiving unit configured to receive the backoff change information and the transmission signal; a model creation unit configured to, in response to the receiving unit receiving a reference signal that is the transmission signal having a known characteristic when receiving the backoff change information, create a compensation model for use in processing to compensate for distortion of the transmission signal transmitted from the transmitter, based on the received reference signal; and a compensation unit configured to compensate for the distortion of the transmission signal using the compensation model created by the model creation unit.

According to some aspects of the present invention, it is possible to suppress degradation of communication quality when the transmitter performs backoff.

Other features and advantages of the present invention will be apparent from the following description taken in conjunction with the accompanying drawings. Note that the same reference numerals denote the same or like components throughout the accompanying drawings.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 illustrates an overview of a communication system Si according to a first embodiment;

FIG. 2 shows a configuration of a communication apparatus 1 according to the first embodiment;

FIG. 3 shows an outline of compensation models stored in a storage unit 13;

FIG. 4 shows a configuration of a communication apparatus 10 according to a second embodiment;

FIG. 5 schematically shows an operation of a model creation unit 145;

FIG. 6 shows a configuration of a communication apparatus S2 according to a third embodiment; and

FIG. 7 is a flowchart illustrating the flow of processing performed by the communication apparatus 10.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Overview of communication system S1

### First Embodiment

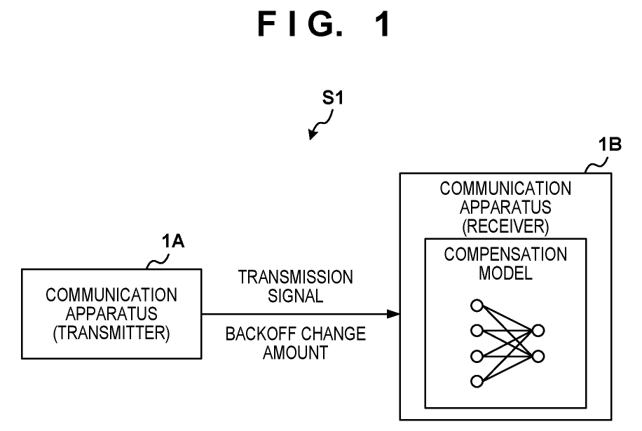

FIG. 1 illustrates an overview of a communication system S1. The communication system S1 includes a communication apparatuses 1A and 1B. The communication apparatus 1A functions as a transmitter, and the communication apparatus 1B functions as a receiver. The communication apparatuses 1A and 1B are, for example, apparatuses having a radio communication function, and the communication apparatus 1A can transmit radio signals to the communication apparatus 1B.

The communication apparatus 1A has a power amplifier and performs backoff to input to the power amplifier a signal with a power level lower than the maximum power level that can be input to the power amplifier. The communication apparatus 1A changes a backoff amount, which is a difference between an output saturation power level of the power amplifier and a maximum amplitude level of a signal input to the power amplifier, in accordance with various conditions.

The communication apparatus 1A increases the backoff amount to suppress interference when, for example, it may interfere with other nearby communication apparatuses, and decreases the backoff amount when interference is unlikely to occur and it is better to improve the efficiency of the power amplifier. In the following description, the amount by which the backoff amount changes from a reference value (e.g., initial value) is referred to as a "backoff change amount".

The communication apparatus 1A outputs a transmission signal and transmits the backoff change amount to the communication apparatus 1B. For example, the communication apparatus 1A transmits the backoff change amount via a physical layer control channel, a MAC layer, or RRC signaling in a wireless communication channel between the communication apparatus 1A and the communication apparatus 1B. The communication apparatus 1B stores a compensation model for compensating for nonlinear distortion of a received transmission signal, and can obtain a distortion-compensated signal by inputting the transmission signal to the compensation model.

When the communication apparatus 1A changes the backoff amount, the characteristics of the distortion of the transmission signal also changes. The communication apparatus 1B switches the compensation model based on the backoff change amount received from the communication apparatus 1A. This makes it possible to compensate for the distortion of a transmission signal by using a compensation model suitable for compensating for the distortion of the transmission signal after the backoff amount has changed. As a result, the communication apparatus 1B can properly compensate for distortion even if the backoff amount of the communication apparatus 1A changes. This allows the communication apparatus 1B to prevent degradation of communication quality (e.g., SN ratio).

Note that the communication apparatuses 1A and 1B may have equivalent communication functions, or may have different communication functions. The communication apparatus 1A is, for example, a base station device, and the communication apparatus 1B is, for example, a communication terminal. In the following description, the configuration and operation of the communication apparatus 1 are described based on the assumption that the communication apparatuses 1A and 1B have equivalent functions. The communication apparatuses 1A and 1B may have some of the functions of the communication apparatus 1 described below.

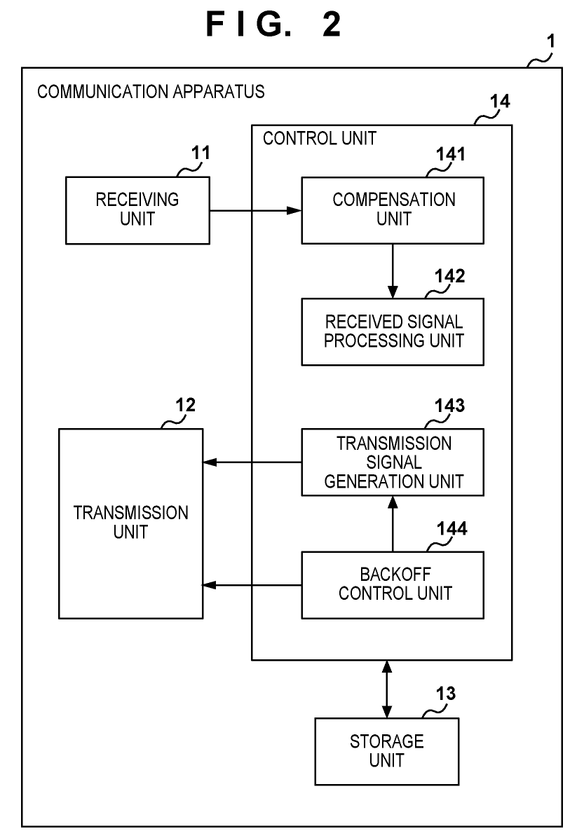

FIG. 2 shows a configuration of the communication apparatus 1 according to the first embodiment. The communication apparatus 1 includes a receiving unit 11, a transmission unit 12, a storage unit 13, and a control unit 14. The control unit 14 includes a compensation unit 141, a received signal processing unit 142, a transmission signal generation unit 143, and a backoff control unit 144.

The compensation unit 141 and the received signal processing unit 142 in FIG. 2 work when the communication apparatus 1 operates as the communication apparatus 1B in FIG. 1. The transmission signal generation unit 143 and the backoff control unit 144 in FIG. 2 work when the communication apparatus 1 operates as the communication apparatus 1A in FIG. 1.

The receiving unit 11 receives from the transmitter (e.g., communication apparatus 1A) a backoff change amount indicating an amount by which the backoff amount of the transmitter has changed from a reference value, and a transmission signal transmitted by the transmitter. The receiving unit 11 inputs the received transmission signal to the compensation unit 141.

The transmission unit 12 transmits a signal to the other communication apparatus. For example, when the communication apparatus 1 functions as the communication apparatus 1A, the transmission unit 12 transmits a transmission signal input from the transmission signal generation unit 143 and a backoff change amount input from the backoff control unit 144. The transmission unit 12 has a power amplifier and transmits the signal input from the transmission signal generation unit 143 after amplifying the signal.

The storage unit 13 has a storage medium such as a read only memory (ROM), a random access memory (RAM), or a solid state drive (SSD). The storage unit 13 stores a program to be executed by the control unit 14. The storage unit 13 also stores compensation models to be used by the compensation unit 141 to compensate for distortion of transmission signals received by the receiving unit 11.

While the compensation models may be of any type, for example, digital post-distortion (DPoD) models are used. The compensation models may be of a polynomial type or models using a neural network. The compensation models may be notified from the transmitter, or may be models generated by the communication apparatus 1 based on a reference signal with known characteristics among transmission signals received by the receiving unit 11.

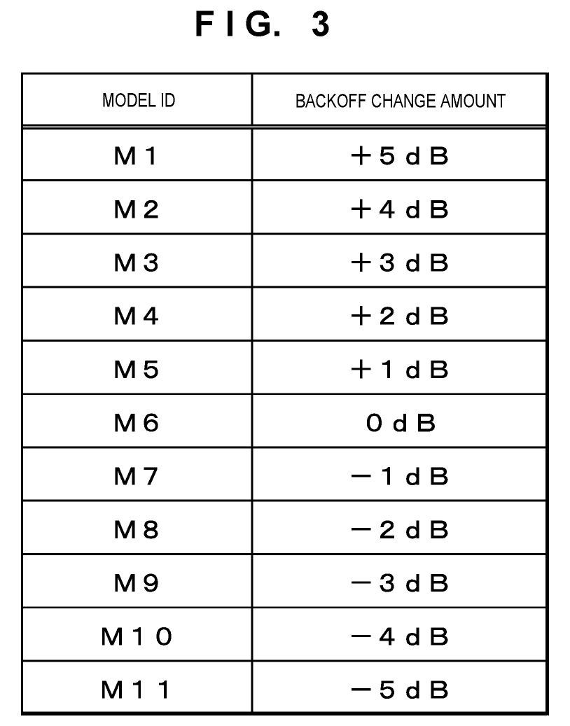

FIG. 3 shows an outline of the compensation models stored in the storage unit 13. The storage unit 13 stores a plurality of compensation models in association with backoff change amounts. FIG. 3 indicates that a different compensation model is stored for each 1 dB of the backoff change amounts from +5 dB to -5 dB. Each compensation model is given a model ID for identifying the compensation model.

Note that when communication apparatus 1 communicates with a plurality of transmitters, it is expected that the distortion occurring in the transmission signals will differ depending on the transmitter. Therefore, the storage unit 13 may store different compensation models in association with the transmitters.

The control unit 14 includes, for example, a central processing unit (CPU) or a digital signal processor (DSP). The control unit 14 functions as the compensation unit 141, the received signal processing unit 142, the transmission signal generation unit 143, and the backoff control unit 144 by executing programs stored in the storage unit 13.

The compensation unit 141 compensates for distortion of a transmission signal using a compensation model for use in processing to compensate for distortion of transmission signals transmitted from the transmitter that is determined based on the backoff change amount notified from the transmitter. The compensation unit 141 inputs the transmission signal to the compensation model, and inputs the transmission signal whose distortion has been compensated for with the compensation model to the received signal processing unit 142.

The compensation unit 141 determines the compensation model stored in the storage unit 13 in association with the backoff change amount notified from the transmitter as the compensation model to be used in processing to compensate for distortion of the transmission signal. For example, when the compensation unit 141 receives from the transmitter notification that the backoff amount has changed, the compensation unit 141 switches from the previously used compensation model to the compensation model corresponding to the notified backoff amount.

For example, it is assumed that the compensation unit 141 uses a compensation model with a model ID of M6 corresponding to a backoff change amount of 0 dB in its initial state. The compensation unit 141 switches the compensation model to be used to a compensation model with a model ID of M8 in response to receiving notification that the backoff change amount is -2 dB.

The compensation unit 141 may select the compensation model stored in the storage unit 13 in association with the transmitter that has transmitted the transmission signal. When the communication apparatus 1 communicates with a plurality of transmitters, this configuration allows the compensation unit 141 to properly compensate for distortion of transmission signals regardless of differences in characteristics of the transmitters.

The received signal processing unit 142 processes the distortion- compensated signal input from the compensation unit 141. For example, the received signal processing unit 142 causes a speaker to output a sound based on the signal or causes a display to display an image based on the signal.

When the communication apparatus 1 functions as the communication apparatus 1A, the transmission signal generation unit 143 generates a signal to be transmitted to the communication apparatus 1B. For example, the transmission signal generation unit 143 generates a sound signal or an image signal and inputs the generated signal to the transmission unit 12. The transmission signal generation unit 143 changes the backoff amount by changing the amplitude of the generated signal under the control of the backoff control unit 144.

The backoff control unit 144 controls the transmission signal generation unit 143 to change the backoff amount. As described above, for example, the backoff control unit 144 increases the backoff amount to suppress interference with other communication apparatuses, and decreases the backoff amount when it is better to improve the efficiency of the power amplifier. The backoff control unit 144 causes the transmission unit 12 to transmit a backoff change amount that is an amount of change in the backoff amount from a reference value.

### Effects of communication apparatus 1

As described above, the communication apparatus 1 compensates for distortion of a transmission signal using the compensation model determined based on the backoff change amount notified from the transmission apparatus. This allows the communication apparatus 1 to suppress degradation of the quality of a received signal when the transmitter performs backoff.

### Second Embodiment

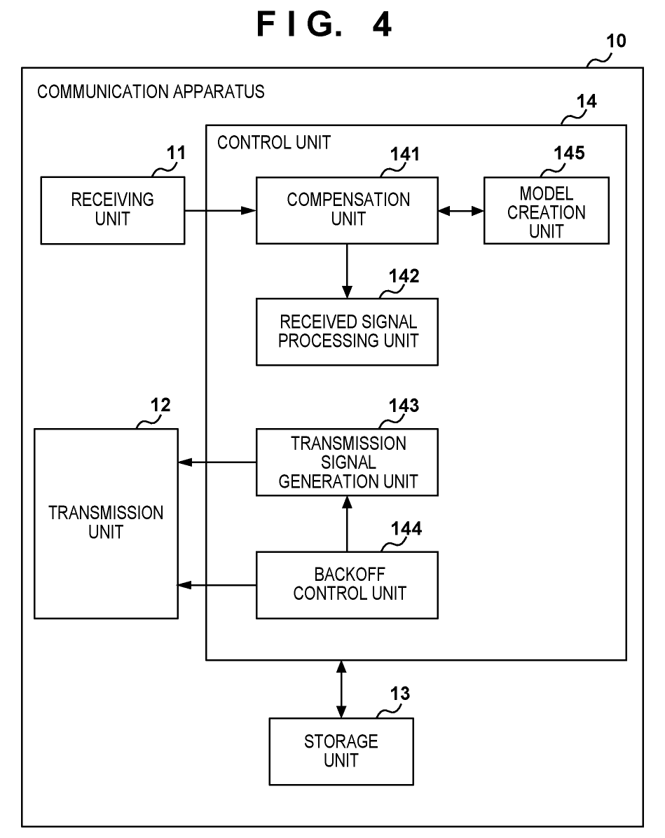

FIG. 4 shows a configuration of a communication apparatus 10 according to the second embodiment. The communication apparatus 10 differs from the communication apparatus 1 shown in FIG. 2 in that it further includes a model creation unit 145, and is otherwise the same.

The model creation unit 145 creates the compensation model described in the first embodiment. For example, when the model creation unit 145 receives the input of the transmission signal and the backoff change amount received by the receiving unit 11, the model creation unit 145 creates a compensation model corresponding to the received signal. When the model creation unit 145 receives the input of a reference signal that is a transmission signal with known characteristics and the backoff change amount are input, the model creation unit 145 creates a compensation model corresponding to the backoff change amount notified from the communication apparatus based on the reference signal. The model creation unit 145 stores the created compensation model in the storage unit 13 in association with the backoff change amount.

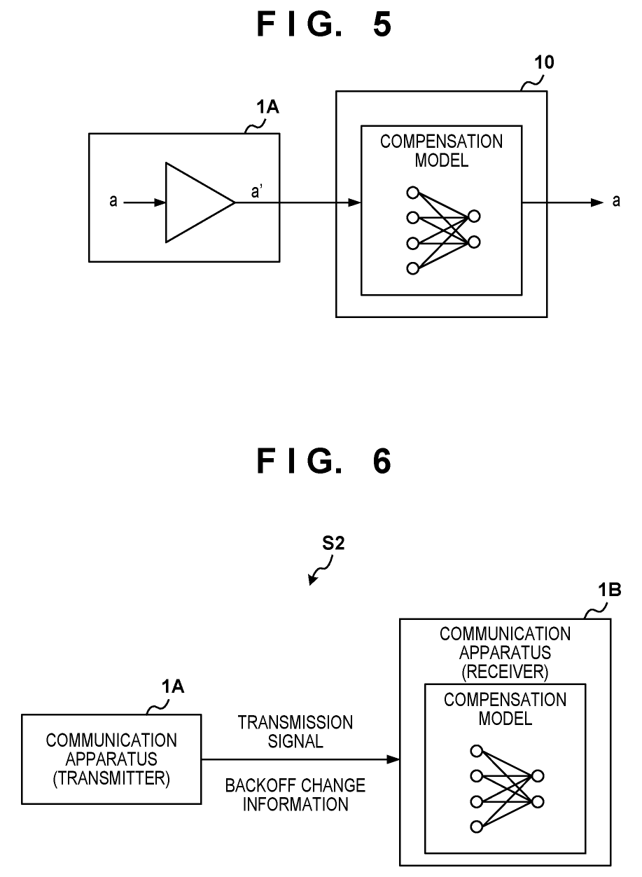

FIG. 5 schematically shows the operation of the model creation unit 145. In FIG. 5, a base reference signal a is distorted by a power amplifier included in the communication apparatus lA and becomes a reference signal a'. The model creation unit 145 creates a compensation model capable of bringing the input reference signal a' close to the original base reference signal a. That is, the model creation unit 145 creates a compensation model capable of reducing the difference between the undistorted base reference signal and the reference signal. The model creation unit 145 uses the created compensation model as the compensation model corresponding to the backoff change amount notified from the transmitter.

The model creation unit 145 may create a plurality of compensation models by adjusting various parameters provided in a base compensation model, and use a compensation model with which a signal obtained by the compensation unit 141 compensating for the reference signal has relatively good quality, out of the plurality of created compensation models, as the compensation model corresponding to the backoff change amount notified from the transmitter.

Each time the receiving unit 11 receives a reference signal, the model creation unit 145 may update the compensation model to minimize the difference between the base reference signal and the received reference signal. As a result of the model creation unit 145 updating the compensation model in this manner, the influence of distortion can be suppressed even if the characteristics of the transmitter or the radio wave propagation environment change.

### Third Embodiment

FIG. 6 shows a configuration of a communication apparatus S2 according to the third embodiment. The communication apparatus 10 according to the second embodiment includes the model creation unit 145 that creates a compensation model corresponding to the backoff change amount received by the receiving unit 11. Meanwhile, the communication apparatus 10 according to the third embodiment is different in that the receiving unit 11 does not receive the backoff change amount but receives backoff change information indicating that the backoff amount has changed.

The model creation unit 145 of the communication apparatus 10 according to the third embodiment differs from that of the second embodiment in that it adaptively re-learns and updates the compensation model based on the received reference signal when receiving the backoff change information. The operations of the units other than the model creation unit 145 in the communication apparatus 10 are equivalent to those of the respective units in the first and second embodiments.

The receiving unit 11 in the third embodiment receives backoff change information indicating that the backoff amount of the transmitter has changed, and a transmission signal transmitted by the transmitter. When the receiving unit 11 receives the backoff change information, the model creation unit 145 creates a compensation model corresponding to a reference signal that is a transmission signal with known characteristics. More specifically, similar to the second embodiment, the model creation unit 145 creates a compensation model by adjusting various parameters provided in a base compensation model to reduce the difference between the base reference signal and the received reference signal.

The compensation unit 141 may cause the model creation unit 145 to start operating when the receiving unit 11 receives backoff change information, and cause the model creation unit to stop the operation of creating a compensation model after the model creation unit 145 has created the compensation model. Such operation of the compensation unit 141 prevents an increase in power consumption due to the model creation unit 145 continuing to update the compensation model even though the backoff amount has not changed.

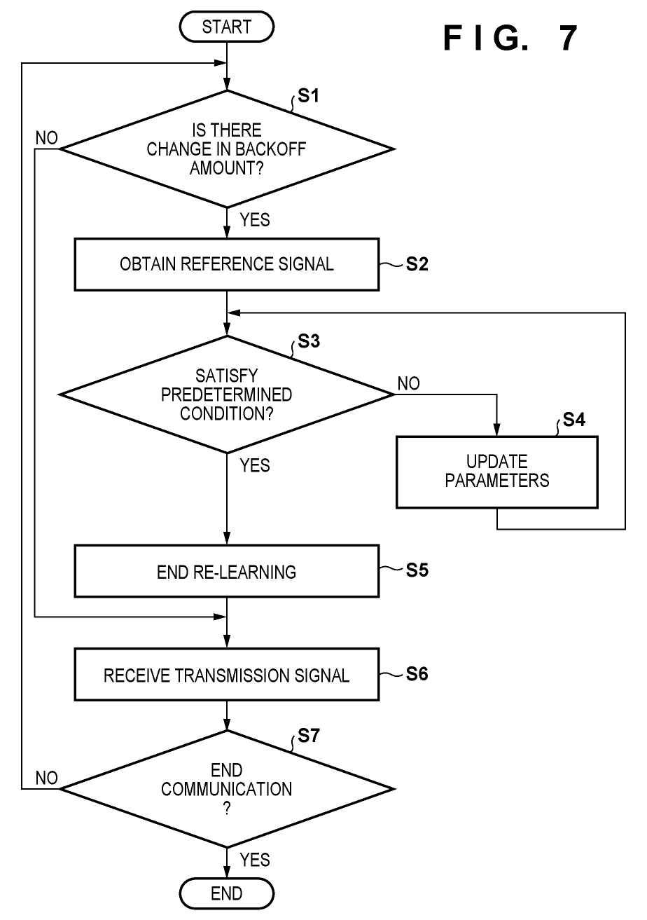

FIG. 7 is a flowchart illustrating the flow of processing performed by the communication apparatus 10. The flowchart shown in FIG. 7 starts from the state where the communication apparatus 10 is receiving transmission signals from the communication apparatus 1A.

The compensation unit 141 monitors whether or not the backoff amount has changed during the communication with the communication apparatus lA (step Si). Specifically, the compensation unit 141 determines whether or not the receiving unit 11 has received backoff change information indicating that the backoff amount has changed. If it is determined that the backoff amount has not changed (NO in step S1), the compensation unit 141 advances processing to step S6 and continues to receive transmission signals.

If it is determined that the backoff amount has changed (YES in step S1), the compensation unit 141 obtains the reference signal received by the receiving unit 11 (step S2) and determines whether or not the reference signal satisfies a predetermined condition (step S3). The predetermined condition is that the communication quality is higher than or equal to a reference level: e.g., the difference between the reference signal and the base reference signal is smaller than or equal to a predetermined value; the SN ratio of the reference signal is higher than or equal to a predetermined value; or a bit error rate of the reference signal is lower than or equal to a predetermined value.

If the reference signal does not satisfy the predetermined condition (NO in step S3), the compensation unit 141 updates the parameters of the compensation model stored in the storage unit 13 to reduce the difference between the reference signal and the base reference signal (step S4). The compensation unit 141 re-learns and updates the parameters of the compensation model, and thereafter determines again whether or not the reference signal satisfies the predetermined condition (step S3).

If it is determined that the reference signal satisfies the predetermined condition (YES in step S3), the compensation unit 141 ends re-learning (step S5) and receives a transmission signal (step S6). The compensation unit 141 repeats processes from step S1 to step S6 unless the communication ends (NO in step S7).

### Effects of communication apparatus 10 according to third embodiment

As described above, the communication apparatus 10 according to the third embodiment is configured such that, upon the receiving unit 11 receiving notification that the backoff amount has changed, the model creation unit 145 updates the compensation model adaptively based on the state of the reference signal received by the receiving unit 11. Such operation of the model creation unit 145 allows the communication apparatus 1 to eliminate non-linear distortion of the received transmission signal even in the case where the transmitter does not transmit the backoff change amount.

Although the present invention has been described above using the embodiments, the technical scope of the present invention is not limited to the scope described in the above embodiments, and various modifications and changes are possible within the scope of the gist thereof. For example, all or part of the apparatus can be functionally or physically distributed and integrated in any unit. New embodiments resulting from any combination of multiple embodiments are also included in the embodiments of the present invention. The effects of the new embodiments resulting from the combination includes the effects of the original embodiments.

For example, the communication apparatus 1 and the communication apparatus 10 illustrated in the above description each have the compensation unit 141 and the backoff control unit 144. However, the communication apparatus 1 and the communication apparatus 10 may each have only one of the compensation unit 141 and the backoff control unit 144. Specifically, if the communication apparatus 1 or the communication apparatus 10 is, for example, a base station device, it may be configured to have the backoff control unit 144 but not have the compensation unit 141. On the other hand, if the communication apparatus 1 or the communication apparatus 10 is a terminal that communicates with a base station device capable of changing the backoff amount, the communication apparatus 1 or the communication apparatus 10 may be configured to have the compensation unit 141 but not have the backoff control unit 144.

In the above description, the backoff change amount is a value indicating a difference between the backoff amount and the reference value, but the backoff change amount may be a value indicating an absolute value of the backoff amount.

Note that the present invention will contribute to Goal 9 of the Sustainable Development Goals (SDGs) initiated by the United Nations, "Build resilient infrastructure, promote inclusive and sustainable industrialization, and promote innovation and resilience."

The present invention is not limited to the above embodiment, and various changes and modification may be made without departing from the spirit and scope of the present invention. Therefore, in order to make the scope of the present invention public, the following claims are attached.

What is claimed is:

1. A communication apparatus comprising:
a receiving unit configured to receive, from a transmitter, a backoff change amount indicating an amount by which a backoff amount of the transmitter has changed from a reference value, and a transmission signal transmitted by the transmitter; and
a compensation unit configured to compensate for distortion of the transmission signal using a compensation model for use in processing to compensate for the distortion of the transmission signal transmitted from the transmitter, the compensation model being determined based on the backoff change amount.

2. The communication apparatus according to claim 1, further comprising:
a storage unit configured to store a plurality of compensation models in association with backoff change amounts,
wherein the compensation unit determines a compensation model stored in the storage unit in association with the backoff change amount received by the receiving unit as the compensation model for use in the processing to compensate for the distortion of the transmission signal.

3. The communication apparatus according to claim 1, further comprising: a model creation unit configured to, upon receiving input of the backoff change amount and a reference signal that is the transmission signal received by the receiving unit and having a known characteristic, create the compensation model corresponding to the backoff change amount, based on the reference signal.

4. The communication apparatus according to claim 3,
wherein the model creation unit creates the compensation model capable of reducing a difference between a undistorted base reference signal and the reference signal.

5. The communication apparatus according to claim 3,
wherein the model creation unit creates a plurality of compensation models, and determines, as the compensation model corresponding to the backoff change amount, one compensation model with which a signal obtained after the compensation unit compensates for the reference signal has relatively good quality, out of the plurality of created compensation models.

6. A communication apparatus comprising:
a receiving unit configured to receive backoff change information indicating that a backoff amount of a transmitter has changed, and a transmission signal transmitted by the transmitter;
a model creation unit configured to, in response to the receiving unit receiving a reference signal that is the transmission signal having a known characteristic when receiving the backoff change information, create a compensation model for use in processing to compensate for distortion of the transmission signal transmitted from the transmitter, based on the received reference signal; and
a compensation unit configured to compensate for the distortion of the transmission signal using the compensation model created by the model creation unit.

7. The communication apparatus according to claim 6,
wherein the compensation unit causes the model creation unit to start an operation of creating the compensation model in response to the receiving unit receiving the backoff change information, and causes the model creation unit to stop the operation of creating the compensation model after the model creation unit has created the compensation model.

8. A communication system comprising:
a transmitter; and
a receiver configured to receive a transmission signal transmitted by the transmitter, the transmitter including:
a backoff control unit configured to change a backoff amount; and
a transmission unit configured to transmit a backoff change amount that is an amount by which the backoff amount changes from a reference value, and the transmission signal,
the receiver including:
a receiving unit configured to receive the backoff change amount and the transmission signal; and
a compensation unit configured to compensate for distortion of the transmission signal using a compensation model for use in processing to compensate for distortion of the transmission signal transmitted from the transmitter, the compensation model being determined based on the backoff change amount.

9. A communication system comprising: a transmitter; and
a receiver configured to receive a transmission signal transmitted by the transmitter,
the transmitter including:
a backoff control unit configured to change a backoff amount; and
a transmission unit configured to transmit backoff change information indicating that the backoff amount has changed, and the transmission signal,
the receiver including:
a receiving unit configured to receive the backoff change information and the transmission signal;
a model creation unit configured to, in response to the receiving unit receiving a reference signal that is the transmission signal having a known characteristic when receiving the backoff change information, create a compensation model for use in processing to compensate for distortion of the transmission signal transmitted from the transmitter, based on the received reference signal; and
a compensation unit configured to compensate for the distortion of the transmission signal using the compensation model created by the model creation unit.
